(19) United States
(12) Patent Application Publication
(10) Pub. No.: US 2018/0347736 A1
(43) Pub. Date: Dec. 6, 2018

(54) ENHANCED ERGONOMIC SPRING CLAMP RETAINER

(71) Applicant: GM GLOBAL TECHNOLOGY OPERATIONS LLC, DETROIT, MI (US)

(72) Inventors: Benjamin Felipe Garcia Lopez, Toluca (MX); Jonathan D'Andonaegui Pacheco, Mexico City (MX)

(21) Appl. No.: 15/610,857

(22) Filed: Jun. 1, 2017

(51) Int. Cl. F16L 33/12; F16B 2/24

(52) U.S. Cl. CPC F16L 33/12; F16B 2/245

(57) ABSTRACT

A spring clamp retainer includes a first end configured for retaining a spring clamp in an unclamped state until removed, a second end configured for grasping with at least one finger. An intermediate portion extends between the first and second end that includes a top and bottom surface wherein the top surface is configured for resting a thumb and holding in the palm of a hand, and the bottom surface is configured for grasping with at least one other finger.

### TECHNICAL FIELD

The following disclosure relates generally to spring clamp retainers and, more particularly, to an enhanced ergonomic spring clamp retainer.

### BACKGROUND

A spring clamp is a fastener used to quickly and securely attach a hose to a piece on equipment on a vehicle or other piece of machinery. Mostly formed as a preloaded piece of material, often metallic, that when released will spring shut and clamp a hose to a fluid port of a piece of equipment instantaneously.

Spring clamps are particularly suited for confined or otherwise awkward places where other clip types would require tightening tools applied from narrow and possibly inaccessible angles. In some instances, the spring clamp is preloaded onto a hose in the unclamped or unreleased condition with a retainer clip until the hose is set in place at its connection point and the retainer clip is removed or popped off by hand to release the spring clamp for securing the hose connection.

The retainer clips are designed to maintain the spring clamps in the unclamped state for shipping and handling, and ultimately, removal by the installer of the spring clamp who in some cases may be required to remove several retainer clips as part of an equipment installation process. Thus, the removal of the retainer clips should be made ergonomically easy for the installer to minimize fatigue, stress and even injury. Accordingly, although designs of current retainer clips for spring clamps are suitable for fulfilling intended purposes, more ergonomically designed retainer clips are desirable for the enhanced comfort, reduced fatigue, and increased productivity as these factors relate to retainer clip removal.

### BRIEF SUMMARY

One or more exemplary embodiments address the above issue by providing an enhanced ergonomic spring clamp retainer having an extended lever arm and grip surface to accommodate more than one finger. Accordingly, aspects of an exemplary embodiment of a spring clamp retainer include a first end configured for retaining a spring clamp in an unclamped state until removed, a second end configured for grasping with at least one finger, and an intermediate portion extending between the first and second end having a top surface and a bottom surface wherein the top surface is configured for resting a thumb and the bottom surface is configured for grasping with at least one other finger.

Another aspect of the exemplary embodiment includes a ring disposed at the second end for inserting the at least one finger. And another aspect includes the spring clamp retainer being made from a rigid plastic material. And still another aspect includes the spring clamp retainer being formed of a polyamide material.

Yet another aspect of as according to the exemplary embodiment wherein the top surface of the spring clamp retainer further includes being configured for holding in the palm of a hand. And another aspect wherein the bottom surface further includes being contoured to for grasping with at least two fingers. Still another aspect wherein the top and bottom surfaces of the spring clamp retainer are substantially flat. And still another aspect of the exemplary embodiment wherein a bottom surface of the second end is configured as semi-circular.

### BRIEF DESCRIPTION OF THE DRAWINGS

At least one example of the present invention will hereinafter be described in conjunction with the following figures, wherein like numerals denote like elements, and:

FIG. 1 is an illustration of a single finger spring clamp retainer installed for retaining a radiator outlet hose clamp;

FIG. 2 is an illustration of a spring clamp retainer having an extended lever arm and grip surface to accommodate more than one finger in accordance with aspects of an exemplary embodiment;

FIG. 3A is an illustration of an alternative embodiment of a spring clamp retainer having an extended lever arm and grip surface to accommodate more than one finger in accordance with the exemplary embodiments of the present disclosure; and

FIG. 3B is an illustration of another alternative embodiment of a spring clamp retainer having an extended lever arm and grip surface to accommodate more than one finger in accordance with aspects of the exemplary embodiment.

### DETAILED DESCRIPTION

The following Detailed Description is merely exemplary in nature and is not intended to limit the invention or the application and uses of the invention. There is no intention to be bound by any theory presented in the preceding Background or the following Detailed Description. The term “exemplary,” as appearing throughout this document, is synonymous with the term “example” and is utilized below to emphasize that the following description should not be interpreted to limit the scope of the invention, as set-out in the appended Claims.

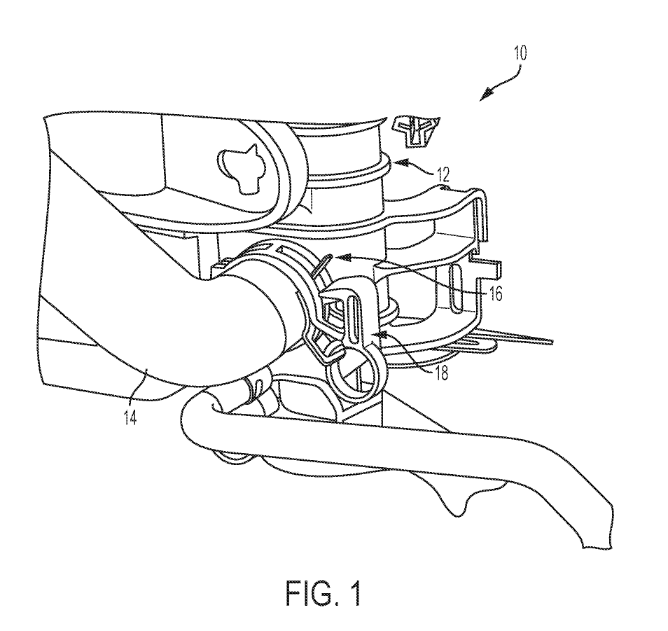

Referring to FIG. 1, an illustration 10 a radiator outlet tank 12 connected to a radiator hose 14 disposed with a spring clamp 16 at the connection point and a single finger spring clamp retainer 18 installed on a radiator outlet hose clamp. The single finger spring clamp retainer 18 is configured with a ring at one end for inserting a finger and providing a bearing surface for the thumb such that the spring clamp retainer 18 can be firmly grasped for removal. It is appreciated that due to limited space for working with tools in an engine compartment that the removal of the spring clamp retainer clips, which is frequently done by hand, should be made ergonomically easy for the component installer to minimize fatigue, stress and even injury. Accordingly, more ergonomically designed retainer clips are desirable for reducing the effort and time it takes for their removal.

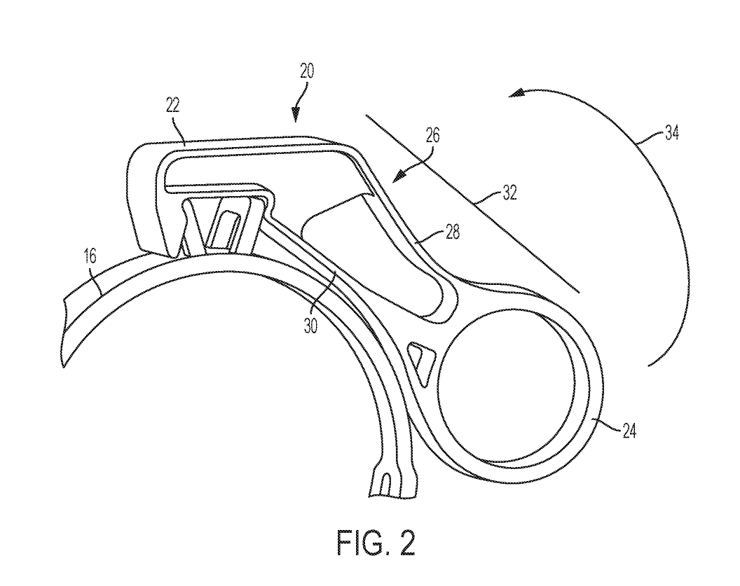

Referring now to FIG. 2, an illustration of a spring clamp retainer 20 having an extended lever arm and grip surface to accommodate more than one finger in accordance with aspects of an exemplary embodiment is provided. The spring clamp retainer 20 includes a first end 22 configured for retaining a spring clamp 16 in an unclamped state until removed. A second end 24 of the spring clamp retainer 20 is configured for grasping with at least one finger. In this case, a ring is disposed at the second end 24 for inserting the at least one finger to reduce grip slip.

An intermediate portion 26 extends between the first end 22 and second end 24 and, in this embodiment, includes a top surface 28 and a bottom surface 30 that are substantially flat wherein the top surface 28 is configured for resting at least a thumb and the bottom surface 30 is configured for grasping with at least one other finger. The intermediate portion 26 serves as a lever arm that extends substantially the distance 32 in which the top surface 28 is not only configured for resting at least a thumb but also to accommodate holding the spring clamp retainer 20 in the palm of a hand. In accordance with the exemplary embodiment, the spring clamp retainer 20 is formed using a rigid plastic material such as a polyamide material although the retainer may be formed from other materials suitable for such purpose without exceeding the scope of this disclosure.

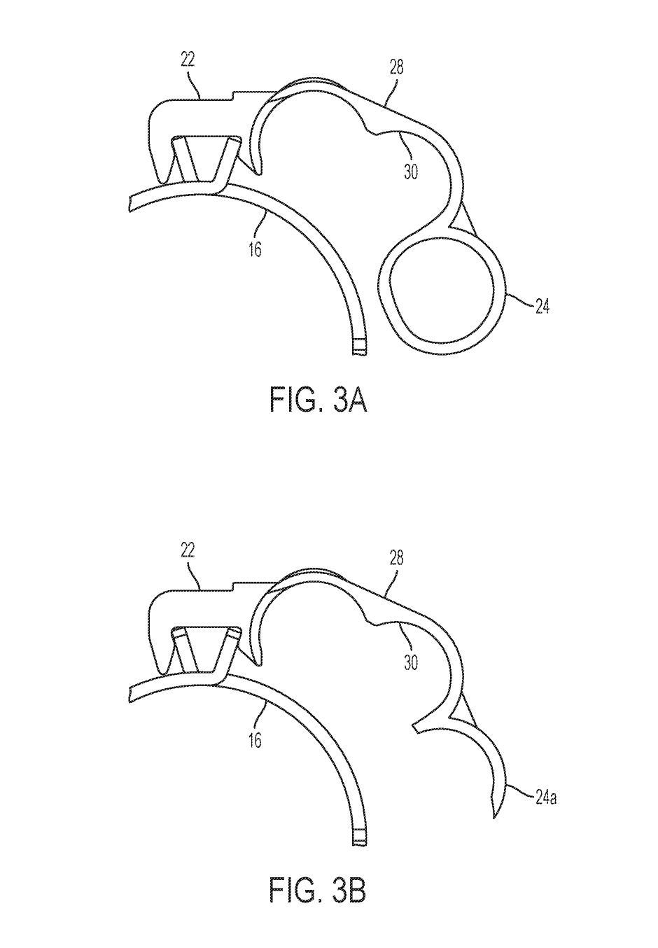

Referring now to FIGS. 3A & 3B, illustrations of alternative embodiments of a spring clamp retainer having an extended lever arm and grip surface to accommodate more than one finger are provided. In FIG. 3A, an alternative embodiment of the spring clamp retainer 20 includes a top surface 28 configured for resting at least a thumb and also to accommodate holding in the palm of the hand. The bottom surface 30 is contoured for grasping with at least two fingers in addition to the second end 24 being disposed with a ring for inserting the at least one finger to minimize grip slip.

FIG. 3B, is another alternative embodiment of the spring clamp retainer 20 and includes a top surface 28 configured for resting at least a thumb and to accommodate holding the spring clamp retainer 20 in the palm of the hand. The bottom surface 30 is contoured for grasping with at least two fingers in addition to the second end 24 being configured as semi-circular portion similar to the contoured bottom surface 30 of the intermediate portion 26.

While at least one exemplary embodiment has been presented in the foregoing Detailed Description, it should be appreciated that a vast number of variations exist. It should also be appreciated that the exemplary embodiment or exemplary embodiments are only examples, and are not intended to limit the scope, applicability, or configuration of the invention in any way. Rather, the foregoing Detailed Description will provide those skilled in the art with a convenient road map for implementing an exemplary embodiment of the invention. Various changes may be made in the function and arrangement of elements described in an exemplary embodiment without departing from the scope of the invention as set-forth in the appended Claims.

1. A spring clamp retainer comprising:
a first end configured for retaining a spring clamp in an unclamped state until removed;
a second end spaced away from tensioning end pieces of the spring clamp and is configured for grasping with at least one finger, wherein said second end is disposed with a ring for inserting at least one finger; and
an extended lever arm extending between the first and second end having a top surface and a bottom surface wherein the top surface of the extended lever arm extends a distance that is configured for resting a thumb and for holding the extended lever arm in the palm of a hand and the bottom surface is configured for grasping with at least two fingers.

2. (canceled)

3. The retainer of claim 1 further comprising being made from a rigid plastic material.

4. The retainer of claim 3 further comprising being formed of a polyamide material.

5. (canceled)

6. (canceled)

7. The retainer of claim 1 wherein the top and bottom surfaces are substantially flat.

8. The retainer of claim 1 wherein a bottom surface of the second end is configured as semi-circular.

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. The retainer of claim 1 wherein the bottom surface of the extended lever arm is contoured for grasping with at least two fingers.
